(19) United States
(12) Patent Application Publication
(10) Pub. No.: US 2007/0048122 A1
(43) Pub. Date: Mar. 1, 2007

(54) Debris-filtering technique for gas turbine engine component air cooling system

(75) Inventors: Arthur J. Van Suetendael IV, Stuart, FL (US); Dmitriy Romanov, Wells, ME (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/214,671

(22) Filed: Aug. 30, 2005

(51) Int. Cl. F03B 11/00

(52) U.S. Cl. 415/115

(57) ABSTRACT

Air cooling passages for a gas turbine engine component, and in particular, a blade outer air seal, are provided with a filtering technique to filter impurities before they can reach a metering location. The air filtering techniques include the provision of a plurality of openings which each have a small cross-sectional area when compared to the cross-sectional area of the metering location. These small openings will filter out impurities before they reach the metering location. The metering location has a cross-sectional area that is greater than the cross-sectional area of any one of the openings, however, the total cross-sectional area of the plurality of openings exceeds the cross-sectional area of the metering location such that adequate air is supplied even if several of the openings are clogged.

### BACKGROUND OF THE INVENTION

This application relates to a method of filtering impurities from air entering a gas turbine component air cooling system, such that cooling passages are not clogged.

Gas turbine engines are provided with a number of functional sections, including a fan section, a compressor section, a combustion section, and a turbine section. Within each of these sections, there are a number of components that are exposed to high heat, and resultant thermal stresses, etc. Thus, it is well known to provide cooling air to internal cooling channels for these components.

The cooling channels often are rather small. As an example, one recently developed type of cooling channel is a so-called microcircuit cooling system. In a microcircuit cooling system, very tiny cooling channels are formed in the turbine components.

For several reasons, the air flow within a gas turbine engine may include dirt or other impurities. As one example, for jet engines operating in a desert, sand is often entrained in the air flow. These impurities can clog the cooling passages. When the passages become clogged, an inadequate supply of air may be delivered for proper cooling of the component. Typically, a necked metering location is formed at some location along the cooling channel. The metering location is intended to meter the air flow, and this metering location is often the smallest cross-sectional area along a cooling air channel. Thus, it is prone to clogging by impurities. This is undesirable.

One particular component that has experienced problems with the above-discussed problem, is an outer air seal for a rotating turbine blade.

### SUMMARY OF THE INVENTION

In the disclosed embodiment of this invention, the cooling channels for gas turbine engine components are provided with a filter upstream of a metering location. The metering location is sized to control air flow. The filter includes a plurality of openings of relatively small size. The openings are each of a cross-sectional area that is less than the cross-sectional area of the metering location. However, the combined area of the plurality of openings exceeds the area of metering location. The plurality of openings remove debris from the air approaching the cooling channels. While any number of the plurality of openings may become clogged, due to the redundant plurality of openings, a number of openings will still remain open to supply adequate air for cooling purposes.

Several embodiments of filters are disclosed. Some are deemed better suited for microcircuit cooling passage technology, and others are deemed better suited for traditional cooling passages. A disclosed application of these techniques is for providing cooling air in a blade outer air seal. However, other gas turbine engine components may benefit from this invention.

In one embodiment, a plurality of openings are formed in an outer face of a component, and separated by lands. Air may pass through these openings, and to a downstream neck that forms a metering location. The metering location has a cross-sectional area that exceeds the cross-sectional area of any one of the openings, however, the combined cross-sectional area of the plurality of openings exceeds the cross-sectional area of the metering location. Thus, any one of the openings may become clogged by impurities, and yet adequate air will still be delivered.

In another embodiment, a central space is provided with outer openings on an outer face of a component, and side openings on side faces. All of the openings deliver air to the central space or plenum, and the air is then delivered to the metering location. Again, any one of the plurality of openings may become clogged by impurities. However, the provision of the plurality of redundant openings ensures that adequate air does reach the cooling passages.

In yet another embodiment, several openings are arranged in a cross. The openings are elongate and relatively thin. Any one of these openings may be clogged with impurities, and yet the other openings will still provide adequate air flow.

In another embodiment, a plate has a number of perforations to provide the openings. This plate is mounted above a plenum, and the metering location is positioned downstream of the plenum.

By providing the relatively small openings upstream of the metering location, the present invention ensures that impurities are filtered before reaching the metering location.

These and other features of the present invention can be best understood from the following specification and drawings, the following of which is a brief description.

### BRIEF DESCRIPTION OF THE DRAWINGS

FIG. 1 is a view of a prior art gas turbine engine shown somewhat schematically.

FIG. 2A is a first cross-sectional view through a first embodiment of the present invention.

FIG. 2B is a cross-sectional view along line 2B-2B of FIG. 2A.

FIG. 3 shows another view of the FIG. 2A embodiment.

FIG. 4 shows a second embodiment.

FIG. 5 is a view spaced by 90° from the FIG. 4 cross-section.

FIG. 6A shows a third embodiment of the present invention.

FIG. 6B is a top view of the FIG. 6A embodiment.

FIG. 7 shows the FIG. 6A embodiment having filtered an impurity particle.

FIG. 8 shows yet another embodiment.

FIG. 9 is a cross-sectional view through the FIG. 8 embodiment.

### DETAILED DESCRIPTION OF THE PREFERRED EMBODIMENT

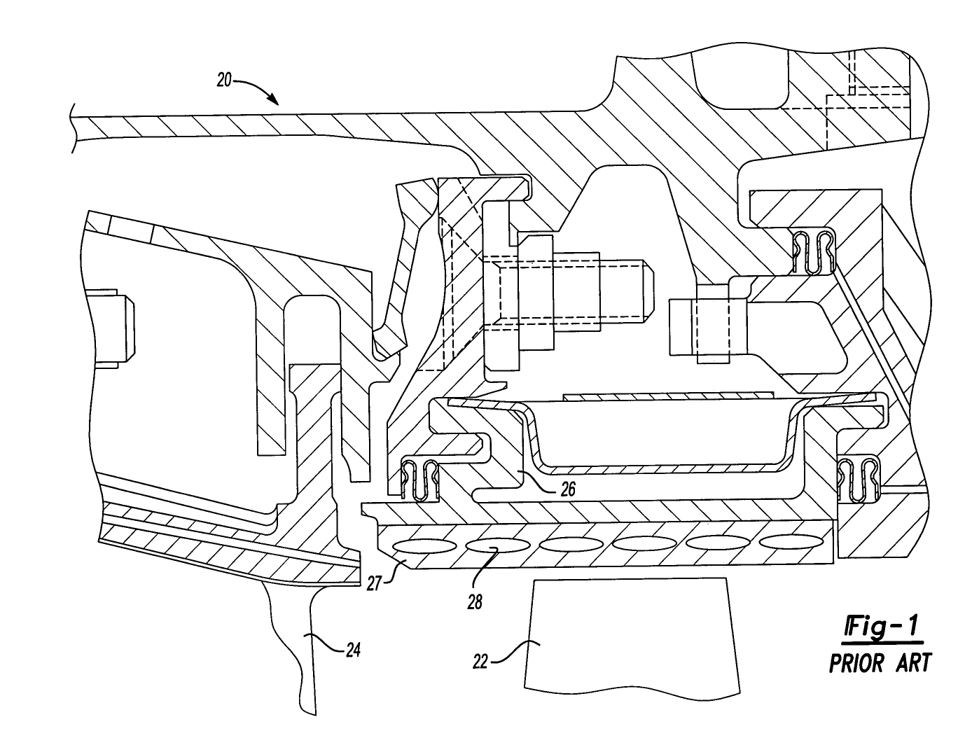

FIG. 1 shows a portion of a gas turbine engine 20 incorporating a rotating turbine blade 22 and a stationary vane 24. As is known, a blade outer air seal 26 is positioned radially outwardly of the turbine blade 22. A housing 27 of the blade outer air seal 26 includes a number of channels 28. The channels are shown somewhat schematically, and may be as known in the prior art. The present invention is directed to providing air flow to the cooling channels such that impurities are filtered before reaching any relatively small location along the channel.

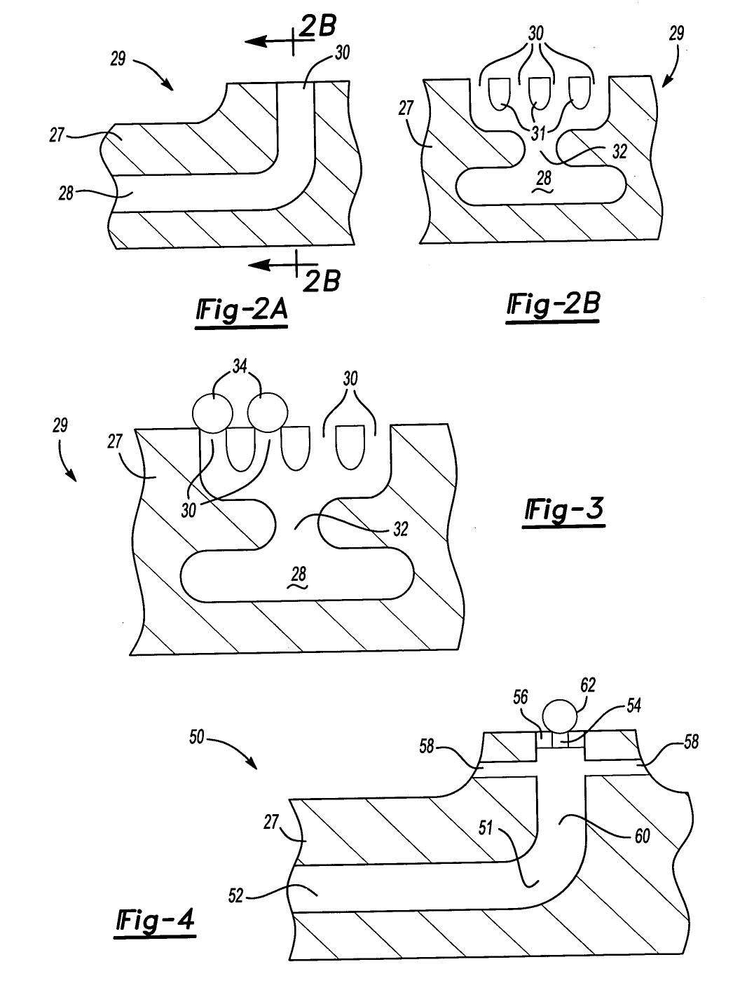

FIG. 2A shows a first embodiment 29. The housing 27 that includes the cooling air passage 28 is provided with an opening 30. This embodiment is particularly useful when the cooling air passages are microcircuit cooling passages. Such microcircuit cooling passages are known, and are formed to an extremely small passage diameter. Thus, these passages are especially prone to being clogged by impurities.

As shown in FIG. 2B, there are actually a plurality of openings 30 spaced by lands 31. The openings 30 all communicate downstream to a metering location 32. The metering location 32 is preferably of a cross-sectional area that is greater than the cross-sectional area of any one of the openings 30. However, the plurality of openings 30 together provide a larger cross-sectional area than the cross-sectional area of metering location 32. In fact, any two openings 30 have a combined cross-sectional area greater than the cross-sectional area of metering location 30.

As shown in FIG. 3, particles of impurities 34 have clogged two of the openings 30. Even so, the provision of the redundant openings 30 provides two unclogged openings. These two openings will provide sufficient air flow to the metering location 32, and downstream to the passage 28. Thus, by having the relatively small openings 30, impurities are filtered before the air reaches the cooling channels 28.

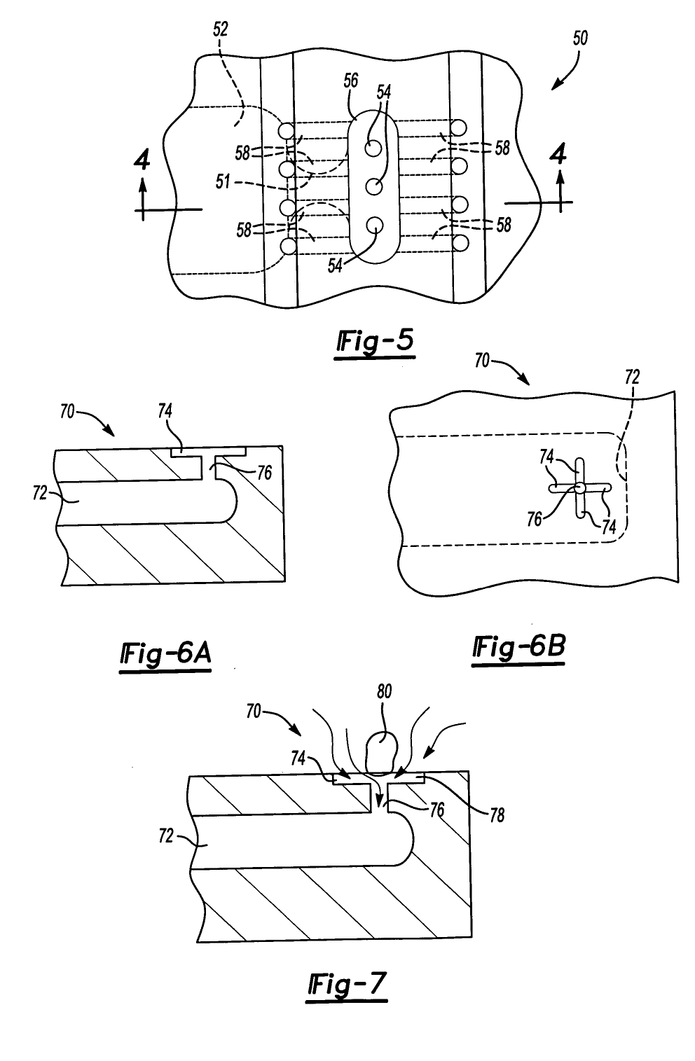

FIG. 4 shows another embodiment 50 wherein the metering location 51 (see FIG. 5) communicates to the flow passage 52. A number of openings 54 are formed in an end face of the housing 27. The openings 54 are formed through a plate 56. Side openings 58 also extend to an entry 60 to the channel. Again, the metering location 51 has a cross-sectional area that is greater than any one of the openings 54 or 58. However, the combined cross-sectional area of openings 54 or 58 exceeds the cross-sectional area of the metering location 51. In fact, any two openings have a greater cross-sectional area than metering location 51.

As shown in FIG. 5, the metering location 51 receives air from the openings 54 and 58. Again, any one of these openings can filter an impurity, while the remaining unclogged openings will supply adequate air. This embodiment is deemed most useful for microcircuit cooling systems.

FIGS. 6A and 6B show another embodiment 70 that is best suited for traditional cooling systems. In embodiment 70, the cooling channel 72 is positioned downstream of the metering location 76. As shown, a plurality of elongated openings 74 form a cross about the metering location 76. As can be appreciated from FIG. 7, the openings 74 ensure that any portion of the cross can be clogged such as by an impurity particle 80, while adequate air will still reach the metering location 76. The openings 74 are each in an area smaller than the area of metering location 76. However, any two openings are greater in area than the metering location.

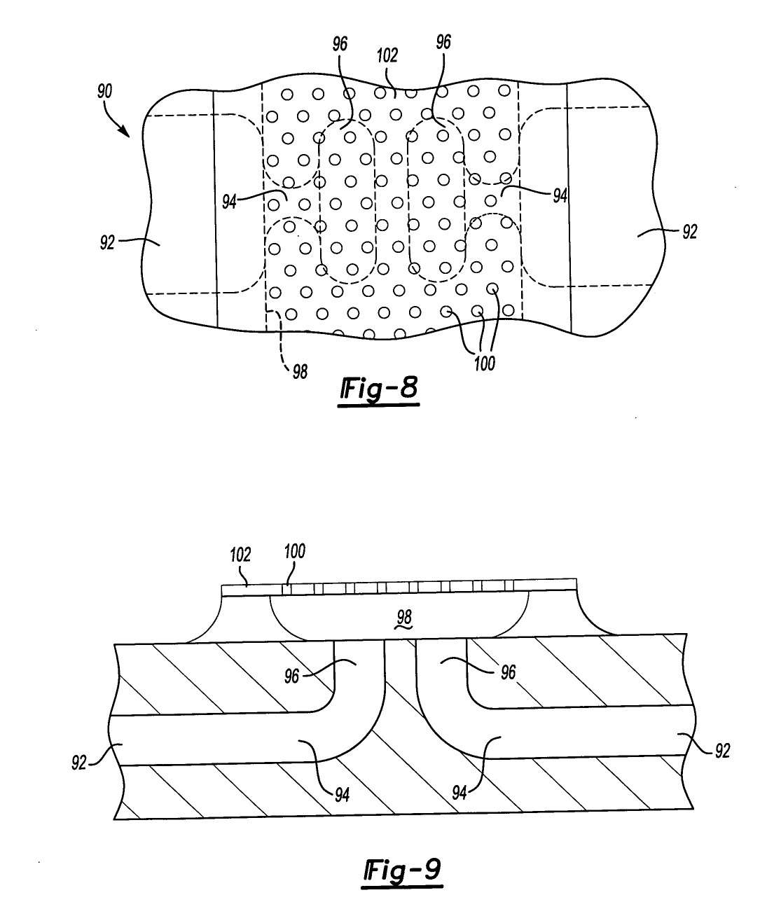

FIGS. 8 and 9 show an embodiment 90 that is suitable for both microcircuit and conventional cooling systems. In this embodiment, the cooling channels 92 receive air from a metering location 94. These metering locations areas are positioned just downstream of an entrance 96. As can be appreciated, an enlarged plenum 98 is positioned downstream of a plate 102. Plate 102 has a plurality of perforations 100. The perforations or openings 100 will filter debris from the air. Any number of these perforations 100 may become clogged, but there will still be adequate air supply to the metering location 94. As with the other embodiments, the cross-sectional area of the metering location 94 exceeds the cross-sectional area of any one of the perforations 100. However, the combined cross-sectional area of all of the perforations 100 exceeds the cross-sectional area of the metering location 94. With this embodiment, the plate 102 may be easily replaced when clogged.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine component comprising:
a body having internal cooling passages; and
a metering location within at least one of said cooling passage, and a plurality of openings upstream of said metering location, said plurality of openings each having a cross-sectional area smaller than a cross-sectional area of said metering location, and a combined cross-sectional area of said plurality of openings exceeding said cross-sectional area of said metering location.

2. The gas turbine engine component as set forth in claim 1, wherein said gas turbine engine component is a blade outer air seal.

3. The gas turbine engine component as set forth in claim 1, wherein said plurality of openings are formed within said body, and in a common plane.

4. The gas turbine engine component as set forth in claim 1, wherein said plurality of openings are formed in said body, and in at least a plurality of planes.

5. The gas turbine engine component as set forth in claim 4, wherein said openings are formed in a first outer face, and in other faces which extend transverse to said first outer face.

6. The gas turbine engine component as set forth in claim 1, wherein said plurality of openings are generally elongate, and intersect each other.

7. The gas turbine engine component as set forth in claim 1, wherein said plurality of openings are perforations in a plate positioned upstream of said metering location.

8. The gas turbine engine component as set forth in claim 7, wherein there is an intermediate enlarged plenum intermediate said plate and said metering location.

9. The gas turbine engine component as set forth in claim 1, wherein a combined cross-sectional area of two of said plurality of openings exceeds said cross-sectional area of said metering location.

10. A gas turbine engine comprising:
at least one stationary vane;
at least one rotating rotor having at least one rotating blade;
at least one blade outer air seal positioned radially outwardly of said at least one rotating blade; and
at least one of said at least one vane, said at least one rotating blade, and said blade outer air seal being provided with a cooling air channel, a metering location within said cooling air channel, and a plurality of openings upstream of said metering location, said plurality of openings each having a cross-sectional area smaller than a cross-sectional area of said metering location, and a combined cross-sectional area of said plurality of openings exceeding said cross-sectional area of said metering location.

11. The gas turbine engine as set forth in claim 10, wherein said at least one of said at least one vane, said at least one rotating blade and said blade outer air seal is said blade outer air seal.

12. The gas turbine engine as set forth in claim 10, wherein said plurality of openings are formed within said body, and in a common plane.

13. The gas turbine engine as set forth in claim 10, wherein said plurality of openings are formed in said body, and in at least a plurality of planes.

14. The gas turbine engine as set forth in claim 13, wherein said openings are formed in a first outer face, and in other faces which extend transverse to said first outer face.

15. The gas turbine engine as set forth in claim 10, wherein said plurality of openings are generally elongate, and intersect each other.

16. The gas turbine engine as set forth in claim 10, wherein said plurality of openings are perforations in a plate positioned upstream of said metering openings.

17. The gas turbine engine as set forth in claim 16, wherein there is an intermediate plenum intermediate said plate and said metering location.

18. The gas turbine engine as set forth in claim 10, wherein a combined cross-sectional area of two of said plurality of openings exceeds said cross-sectional area of said metering location.

19. A method of providing cooling air to a gas turbine engine component comprising the steps of:
(1) providing a body having an internal cooling air channel, said internal cooling air channel being provided with a metering location, and a plurality of openings, said metering location having a cross-sectional area that exceeds a cross-sectional area of each of said plurality of openings, and a combined cross-sectional area of all of said plurality of openings exceeding said cross-sectional area of said metering location; and
passing air through said plurality of openings such that said plurality of openings filter impurities within said air before said impurities reach said metering location.
